(19) United States
(12) Patent Application Publication
(10) Pub. No.: US 2015/0226282 A1
(43) Pub. Date: Aug. 13, 2015

(54) ISOLATORS ENABLING LARGE ROTATION ANGLE CAPABILITIES WITH HIGHLY RESTRICTED DAMPER ORIFICES

(71) Applicant: HONEYWELL INTERNATIONAL INC., Morristown, NJ (US)

(72) Inventors: Timothy Hindle, Peoria, AZ (US); Tim Daniel Barber, Litchfield Park, AZ (US); Ken Young, Peoria, AZ (US)

(73) Assignee: HONEYWELL INTERNATIONAL INC., Morristown, NJ (US)

(21) Appl. No.: 14/177,916

(22) Filed: Feb. 11, 2014

(51) Int. Cl. F16F 9/36; F16F 9/19

(52) U.S. Cl. CPC F16F 9/361; F16F 9/19

(57) ABSTRACT

Embodiments of an isolator are provided. In one embodiment, the isolator includes a damper housing having a radially-extending partition wall through which a central opening is formed. First and second hydraulic chambers are located on opposing sides of the radially-extending partition wall and may be filled with a damping fluid. At least one restricted orifice is formed through the damper housing and fluidly couples the first and second hydraulic chambers. The isolator further includes a damper piston, which extends through the central opening, which is exposed to the damping fluid when the first and second hydraulic chambers are filled therewith, and which is configured to translate along the working axis with respect to the damper housing during operation of the isolator.

### TECHNICAL FIELD

The present invention relates generally to isolation devices and, more particularly, to isolators including fluid dampers and allowing scaling of orifice size to, for example, highly reduced dimensions without limiting rotation angle capabilities.

### BACKGROUND

Isolators commonly include fluid dampers having opposing hydraulic chambers, which are fluidly coupled by an annulus or other restricted orifice and filled with a damping fluid. The viscosity of the damping fluid may be selected based upon the performance requirements of the isolator, including the isolator's operative temperature range. Generally, damping fluids having lower viscosities tend to resist crystallization or solidification and, thus, flow more readily under low temperature conditions. Consequently, in instances wherein the isolator is required to operate at extremely depressed or cryogenic temperatures, such as temperatures approaching or falling below −30° Celsius (° C.), a damping fluid having a very low viscosity (e.g., in the range of about 1 to 10 centistokes or “cS”) may be selected. To enable the usage of such a low viscosity or thin damping fluid, while maintaining isolator performance at acceptable levels, it may be necessary to impart the flow orifice or orifices with highly reduced dimensions. This can present certain difficulties. In instances wherein the orifice assumes the form of an annulus, manufacturing tolerances may render the production of an annulus having a very small radial width unreliable or impractical. Moreover, an isolator having such a highly restricted annulus generally cannot accommodate large angular misalignments between mount points without contact or touch-down between internal surfaces defining the annulus. Other isolator designs are possible, but tend to be characterized by undesirably large envelopes, high sprung masses, high overall weights, increased part counts, and other such limitations.

It would thus be desirable to provide embodiments of an isolator including a fluid damper and enabling damper orifice size to be adjusted independently of the rotation angle capability of the isolator. Advantageously, embodiments of such an isolator could be produced to include highly restrictive flow orifices suitable for usage with low viscosity damping fluids, while simultaneously imparting the isolator with a relatively large rotation angle capability. Ideally, embodiments of such an isolator would further be readily manufacturable, relatively compact, lightweight, and characterized by a relatively low part count and sprung mass. Other desirable features and characteristics of embodiments of the present invention will become apparent from the subsequent Detailed Description and the appended Claims, taken in conjunction with the accompanying drawings and the foregoing Background.

### BRIEF SUMMARY

Embodiments of an isolator are provided. In one embodiment, the isolator includes a damper housing having a radially-extending partition wall through which a central opening is formed. First and second hydraulic chambers are located on opposing sides of the radially-extending partition wall and may be filled with a damping fluid. At least one restricted orifice is formed through the damper housing and fluidly couples the first and second hydraulic chambers. The isolator further includes a damper piston, which extends through the central opening, which is exposed to the damping fluid when the first and second hydraulic chambers are filled therewith, and which is configured to translate along the working axis with respect to the damper housing during operation of the isolator.

In a further embodiment, the isolator includes opposing hydraulic chambers, which are configured to be filled with a damping fluid; and a damper piston, which has a piston shaft generally co-axial with the working axis. The damper piston is exposed to the damping fluid when the opposing hydraulic chambers are filled therewith. An annular air gap or void surrounds the piston shaft and is circumscribed by the opposing hydraulic chambers.

In a still further embodiment, the isolator includes first and second hydraulic chambers configured to be filled with a damping fluid. A radially-extending partition wall is disposed between the first and second hydraulic chambers and has a central opening therein. At least one restricted orifice is formed through the radially-extending partition wall and fluidly couples the first and second hydraulic chambers. A damper piston is movably coupled to the radially-extending partition wall and includes a piston shaft extending through the central opening. First and second externally-pressurized bellows are each sealingly coupled between the radially-extending partition wall and the damper piston. The isolator further includes an annular air gap or void, which is bounded along its inner circumference by the piston shaft and along its outer circumference by the first externally-pressurized bellows, the second externally-pressurized bellows, and the central opening.

### BRIEF DESCRIPTION OF THE DRAWINGS

At least one example of the present invention will hereinafter be described in conjunction with the following figures, wherein like numerals denote like elements, and:

FIG. 1 is an isometric view of an isolator including a fluid damper, as illustrated in accordance with an exemplary and non-limiting embodiment of the present invention;

FIG. 2 is an isometric cross-sectional view of the exemplary isolator shown in FIG. 1 and illustrated prior to filling with a damping fluid; and

FIG. 3 is a side cross-sectional view of the exemplary isolator shown in FIGS. 1 and 2 and illustrated after filling with a damping fluid.

### DETAILED DESCRIPTION

The following Detailed Description is merely exemplary in nature and is not intended to limit the invention or the application and uses of the invention. Furthermore, there is no intention to be bound by any theory presented in the preceding Background or the following Detailed Description. As appearing herein, the term “about” is utilized to denote a disparity of less than 10%. As further appearing herein, the term “orifice” is utilized to denote any opening, flow passage, or channel formed through a larger structure and fluidly coupling at least two hydraulic chambers. Finally, as still further appearing herein, the term “isolator” is utilized in reference to a device that reduces the transmission of vibrations or other disturbance forces between at least two objects or mount points and that includes or assumes the form of a fluid damper.

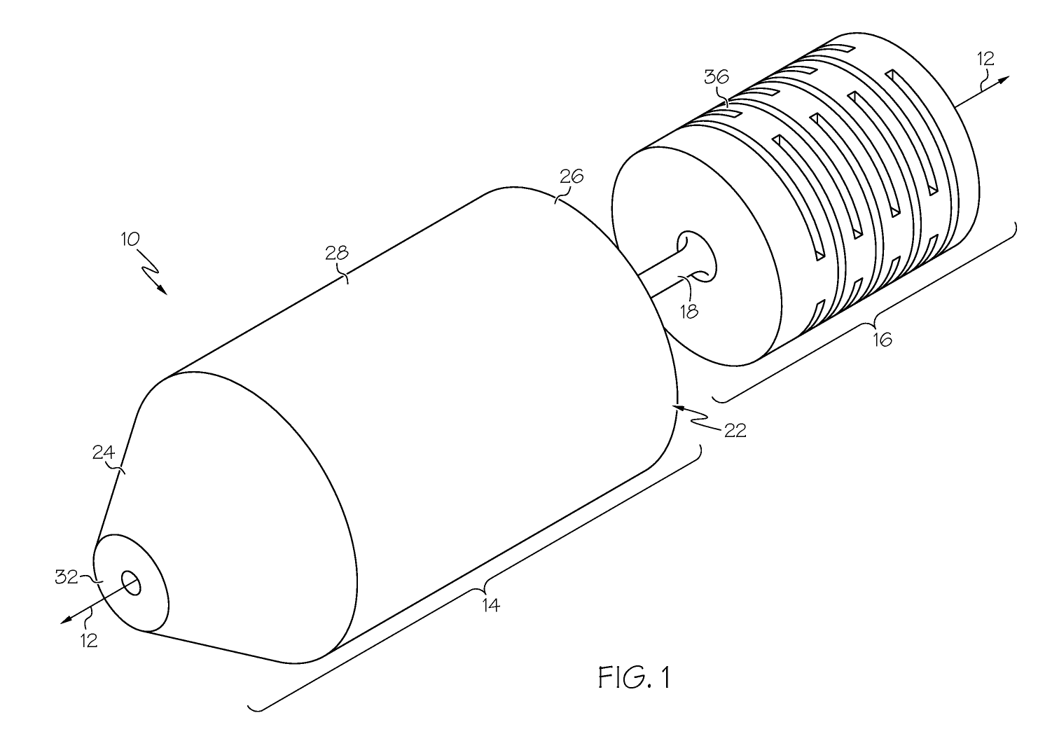

FIGS. 1, 2, and 3 are isometric, isometric cross-sectional, and side cross-sectional views, respectively, of an isolator 10, as illustrated in accordance with an exemplary embodiment of the present invention. In this case, isolator 10 is a three parameter device that behaves, at least in part, as a primary spring coupled in parallel with a series-coupled secondary spring and fluid damper. It will also be noted that isolator 10 is a single degree-of-freedom (axially-damping) device having a working axis 12 corresponding to the longitudinal axis or centerline of isolator 10. Isolator 10 is thus well-suited for usage in a multi-point mounting arrangement; e.g., isolator 10 can be combined with a number of like isolators in, for example, a hexapod or octopod-type mounting arrangement to provide high fidelity damping in six degrees of freedom. Such multi-point mounting arrangements are usefully employed in spacecraft isolation systems utilized to attenuate vibrations or impact forces transmitted between a spacecraft and a payload carried by the spacecraft. It is emphasized, however, that isolator 10 can be utilized in any spaceborne, airborne, terrestrial, or other application wherein it is desired to attenuate vibrations or impact loads between two objects or mount points.

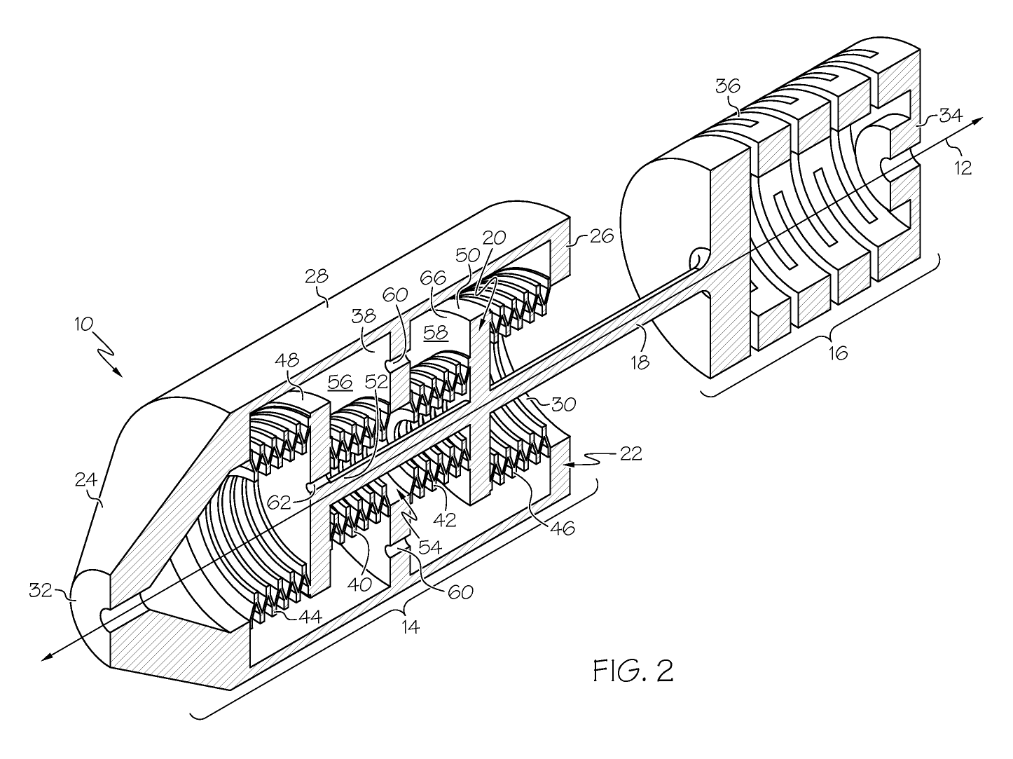

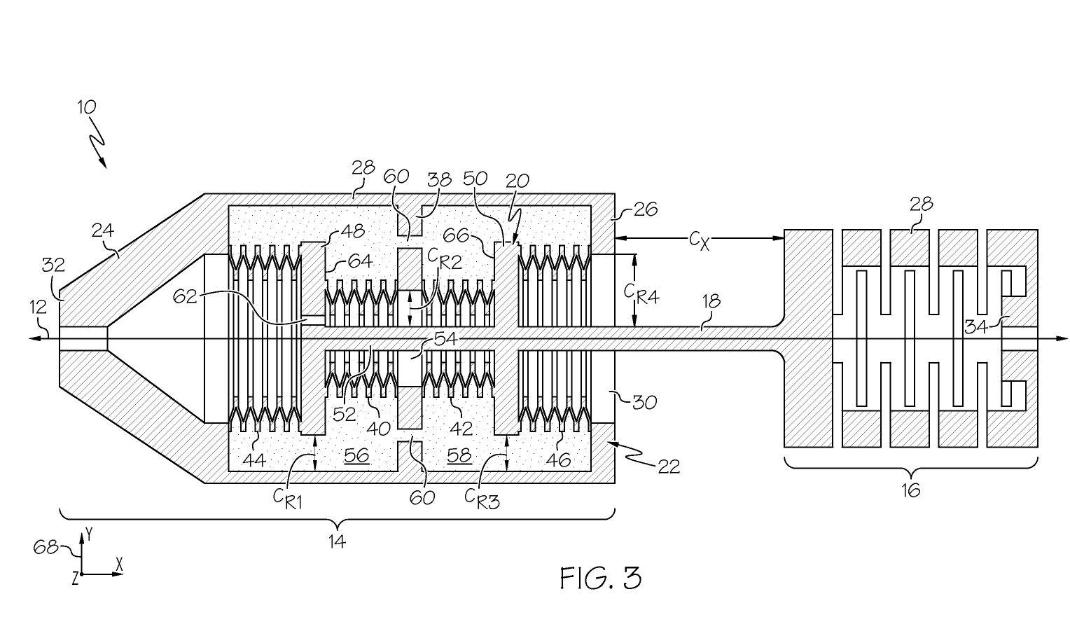

Isolator 10 includes a fluid damper 14 and an end piece 16, which are longitudinally spaced along working axis 12. Fluid damper 14 includes, in turn, a damper piston 20 (FIGS. 2 and 3) contained within a damper housing 22. Damper housing 22 has a first end portion 24, a second end portion 26 proximate end piece 16, and a tubular body 28 between end portions 24 and 26. A central opening 30 (FIGS. 2 and 3) is provided in second end portion 26 of damper housing 22. An axially-elongated connector rod 18 or “stinger” extends from damper piston 20, through opening 30, and to end piece 16 to fixedly join piston 20 to end piece 16. Damper piston 20, connector rod 18, and end piece 16 translate with respect to damper housing 22 along working axis 12 during operation of isolator 10. Connector rod 18 is imparted with a sufficient length to provide an axial standoff or clearance between end piece 16 and damper housing 22 (identified in FIG. 3 as “C_{X}”) allowing such relative translational movement. Additional axial clearances are also provided between damper piston 20 and the interior surfaces of damper housing 22 to allow piston 20 to freely translate within housing 22, as described more fully below.

Isolator 10 further includes at least two mounting interfaces permitting installation of isolator 10 within a larger isolation system. For example, as shown in FIGS. 1-3, a first mounting interface 32 may be integrally formed in end portion 24 of damper housing 22 opposite end piece 16. Similarly, as shown in FIGS. 2 and 3, a second mounting interface 34 may be integrally formed in an end wall of end piece 16 opposite fluid damper 14. When isolator 10 is installed within an isolation system, mounting interfaces 32 and 34 may be attached to the bodies, structures, or devices between which it is desired to reduce the transmission of disturbance forces. Any suitable attachment hardware (e.g., brackets and fasteners) or other attachment means (e.g., welding, soldering, or bonding) may be utilized to provide the desired connections. In certain implementations, mounting interface 32 may be attached to palette or bench supporting a vibration-sensitive payload (e.g., an optical payload) or a vibration-generating payload (e.g., an array of control moment gyroscopes, reaction wheels, or other attitude adjustment devices), while opposing mounting interface 34 is mounted to a spacecraft, an aircraft, or other platform carrying the payload. Alternatively, this mounting arrangement may be inverted such that mounting interface 32 is mounted to the platform, while mounting interface 34 is attached to the payload.

With continued reference to the exemplary embodiment shown in FIGS. 1-3, end piece 16 includes a tubular body in which a machined spring 36 is formed. Specifically, a number of openings or voids may be cut into or otherwise formed in the annular sidewall of end piece 16 to define spring 36. Machined spring 36 is coupled in series with damper piston 20 (FIGS. 2 and 3) and is integral to tuning of isolator 10. For this reason, machined spring 36 is commonly referred to as a “tuning spring.” End piece 16 may include a different type of tuning spring (e.g., a coil spring) or may not include a tuning spring in other implementations. Additionally, in further embodiments of isolator 10, end piece 16 may be fabricated to include one or more cutouts or regions of reduced thickness, which serve as compliant flexure points to help accommodate angular misalignments between mounting interfaces 32 and 34 occurring during original installation of isolator 10 and/or during operation of isolator 10.

Two opposing sets or pairs of bellows are contained within damper housing 22: (i) a first pair of opposing bellows 40 and 42, and (ii) a second pair of opposing bellows 44 and 46. Bellows 40, 42, 44, and 46 may be, for example, edge-welded bellows formed from a stack of convolutes and fabricated from a metal or alloy. Bellows 40 and 42 are referred to herein as the “inner bellows” in view of their positioning between bellows 44 and 46, as taken along working axis 12. Conversely, bellows 44 and 46 are referred to as the “outer bellows” in view of their positioning outside of inner bellows 40 and 42. Stated differently, outer bellows 44 and 46 flank inner bellows 40 and 42, as viewed in cross-section taken along a cut plane parallel to working axis 12. The outer diameters of outer bellows 44 and 46 vary as compared to the outer diameters of inner bellows 40 and 42. For example, outer bellows 44 and 46 may be sized to each have a first outer diameter, while inner bellows 40 and 42 may be sized to have a second outer diameter less than the first outer diameter; e.g., the outer diameters of inner bellows 40 and 42 may be at least 10% or, perhaps, at least 25% less than the outer diameters of bellows 44 and 46. As generally illustrated in FIGS. 2 and 3, the dimensions of outer bellows 44 (e.g., the outer diameter, length, and wall thickness) may be substantially equivalent to the dimensions of outer bellows 46, and the dimensions of inner bellows 40 (e.g., the outer diameter, length, and wall thickness) may be substantially equivalent to the dimensions of inner bellows 42; however, this need not be the case in all embodiments.

Damper housing 22 further includes an intervening structure or internal body, which is disposed between inner bellows 40 and inner bellows 42 and which separates the below-described hydraulic chambers. In the exemplary embodiment shown in FIGS. 1-3, this intervening structure assumes the form of a radially-extending partition wall 38. Partition wall 38 has a generally disc-shaped geometry and extends radially inward from the annular sidewall or tubular body 28 of damper housing 22 toward the centerline or working axis 12 of isolator 10. Outer bellows 44 and inner bellows 40 are positioned on a first side of radially-extending partition wall 38, while inner bellows 42 and outer bellows 46 are positioned on a second, opposing side of partition wall 38. Partition wall 38 may be integrally formed with tubular housing body 28 as a single machined piece or, instead, fabricated as a discrete piece that is subsequently joined to tubular body 28 by, for example, welding. More generally, damper housing 22 can be produced from any number of discrete components, which may assembled or joined together utilizing bolts or other fasteners, bonding, welding, threaded interfaces, or any other joinder technique or hardware.

Damper piston 20 (FIGS. 2 and 3) includes three main features or portions, namely, a first radial flange or bellows plate 48, as second radial flange or bellows plate 50, and a piston shaft 52 fixedly joining bellows plates 48 and 50. Bellows plates 48 and 50 thus extend radially outward from opposing ends of piston shaft 52. Bellows plates 48 and 50 are positioned on opposing sides of partition wall 38, and piston shaft 52 extends through a central opening 54 provided in wall 38 to join bellows plate 48 to bellows plate 50. Such a structural configuration (referred to herein as a “through-shaft” configuration or design) provides multiple benefits, as will described more fully below. In the illustrated embodiment, piston shaft 52 is generally co-axial with or extends along the centerline or working axis 12 of isolator 10 and is circumscribed by inner bellows 40, inner bellows 42, and partition wall 38. Additionally, bellows plates 48 and 50 may each be fabricated to have an outer diameter exceeding the diameter of central opening 54 in partition wall 38. Damper piston 20 may be produced as single machine piece or, instead, assembled from multiple discrete pieces. Similarly, damper piston 20 (or a portion of piston 20) may be integrally formed with connector rod 18 or, instead, joined thereto utilizing, for example, a threaded interface.

Moving from left to right in FIGS. 2 and 3, outer bellows 44 is sealingly joined between an inner wall of damper housing 22 and a first face of bellows plate 48; while inner bellows 40 is sealingly joined between a second, opposing face of bellows plate 48 and a first surface of partition wall 38. Inner bellows 42 is further sealingly joined between a second, opposing surface of partition wall 38 and a first face of bellows plate 50. Finally, outer bellows 46 is sealingly joined between a second, opposing face of bellows plate 50 and the inner wall of housing 22 through which opening 30 is formed. The inner circumferential edges of inner bellows 40 and 42 may be joined to partition wall 38 adjacent central opening 54. Circumferential welding, bonding, or any joining technique capable of creating a fluid-tight bonds may be utilized to create the required joints between bellows 40, 42, 44, and 46 and the surrounding structures. By virtue of this construction, damper piston 20 is resiliently suspended within damper housing 22 and may translate with respect thereto along working axis 12.

Fluid damper 14 further includes opposing hydraulic chambers 56 and 58 contained within damper housing 22. Hydraulic chamber 56 is generally defined by the outer circumference of outer bellows 44, bellows plate 48, the outer circumference of inner bellows 40, and damper housing 22 including partition wall 38. Similarly, hydraulic chamber 58 is generally defined by the outer circumference of inner bellows 42, bellows plate 50, the outer circumference of outer bellows 46, and damper housing 22 including partition wall 38. Radially-extending partition wall 38 is located between and generally separates or divides hydraulic chambers 56 and 58. One or more restricted orifices 60 (two of which are shown in FIGS. 2 and 3) are formed in partition wall 38 and fluidly couple hydraulic chambers 56 and 58. As can be seen, restricted orifices 60 may assume the form of non-annular channels or openings formed through partition wall 38. Any number of restricted orifices 60 can be formed through radially-extending partition wall 38. In many cases, multiple orifices 60 will be formed through partition wall 38 and angularly spaced about working axis 12 of isolator 10 for radial symmetry. In still further embodiments, restricted orifices may be formed in the annular sidewall 28 to fluidly couple hydraulic chambers 56 and 58 in addition to or in lieu of the formation of orifices through partition wall 38.

Isolator 10 may initially be produced and distributed without damping fluid, in which case fluid damper 14 may be filled with a selected damping fluid at a chosen juncture after production and prior to deployment of isolator 10. Isolator 10 is illustrated in FIG. 2 in an unfilled state and in a filled state in FIG. 3 (wherein the damping fluid is represented by dot stippling). Filling of fluid damper 14 may be accomplished utilized a non-illustrated fill port, which can be sealed (e.g., via deformation of a metal ball) after filling. As can be seen most readily in FIG. 3, bellows 40, 42, 44, and 46 are externally-pressurized; that is, damping fluid acts on the outer surfaces of bellows 40, 42, 44, and 46 during operation of fluid damper 14. Advantageously, the usage of externally-pressurized bellows decreases the likelihood of buckling or “squirm” as compared to internally-pressurized bellows. Additionally, the externally-pressurized nature of inner bellows 40 and 42 allow an annular air gap or circumferential clearance to be formed between piston shaft 52 and hydraulic chambers 56 and 58, which provides several advantages as described more fully below.

The size, shape, number, and spatial distribution of restricted orifices 60 are limited only by the dimensions of partition wall 38 (and/or by the annular sidewall 28 of damper housing 22, if orifices are formed therethrough). The dimensions and geometries of restricted orifices 60 can thus be adjusted, as appropriate, to tailor isolator 10 to a particular application or usage. Thus, in embodiments wherein it is desired to fill isolator 10 with a very low viscosity damping fluid for operation at extremely depressed temperatures, orifices 60 can be produced to have highly restricted dimensions providing that at least a minimal amount of damping fluid can still flow between hydraulic chambers 56 and 58. For example, in the illustrated example wherein restricted orifices 60 have generally planform circular shapes, as viewed along working axis, the diameters of orifices 60 can be minimized. The length of orifices 60 can also be adjusted, as may be desired, by increasing or decreasing the thickness of radially-extending partition wall 38, by forming orifices 60 at oblique angles relative to working axis 12, and/or by forming orifices 60 to follow non-linear paths (e.g., curved or spiral shaped paths) through partition wall 38.

During operation of isolator 10, relative axial movement occurs between damper housing 22 and damper piston 20, as well as those component rigidly joined to piston 20 (i.e., connector rod 18 and end piece 16). Bellows 40, 42, 44, and 46 expand and compress, as needed, to accommodate such relative axial movement between damper piston 20 and damper housing 22. As bellows 40, 42, 44, and 46 expand and contract, the respective volumes of chambers 56 and 58 vary, and damping fluid is forced through restricted orifices 60. Specifically, as damper piston 20 strokes away from mount point 32 (to the right in FIGS. 1-3), the volume of hydraulic chamber 56 decreases, the volume of hydraulic chamber 58 increases, and damping fluid flows from chamber 56, through orifices 60, and into chamber 58. Conversely, as damper piston 20 strokes toward mount point 32 (to the left in FIGS. 1-3), the volume of hydraulic chamber 56 increases, the volume of hydraulic chamber 58 decreases, and damping fluid flows from chamber 58, through orifices 60, and into chamber 56. The flow of damping fluid through restricted orifices 60, and the resulting viscous losses, provide the desired damping effect by dissipating the kinetic energy transmitted through isolator 10. One or more vent holes 62 may be formed through bellows plate 48 and/or bellows plate 50 inboard of hydraulic chambers 56 and 58 to avoid the creation of a sealed air volume and facilitate deflection of inner bellows 40 and 42.

As indicated above, the volumes of hydraulic chambers 56 and 58 vary in conjunction with movement of piston 20 and deflection of bellows 40, 42, 44, and 46. The variance in volumes of hydraulic chambers 56 and 58 is brought about by the disparity in diameters between outer bellows 44 and inner bellows 40, as well as the disparity in diameters between inner bellows 42 and outer bellows 46. Additionally, bellows plate 48 is sized to have an outer diameter greater than the outer diameter of inner bellows 40 such that an annular region or band 64 (identified in FIG. 3) is created on the face of plate 48 opposite outer bellows 44, which is exposed to damping fluid when hydraulic chamber 56 is filled therewith. Similarly, bellows plate 50 is sized to have an outer diameter greater than the outer diameter of inner bellows 40 such that an annular region or band 66 (identified in FIGS. 2 and 3) is created on the face of plate 50 opposite outer bellows 46, which is exposed to damping fluid when hydraulic chamber 56 is filled therewith. The outer diameters of bellows plates 48 and 50 may also exceed the diameter of inner bellows 40 and 42, central opening 54 in partition wall 38, and central opening 30 in end portion 26 of damper housing 28. By comparison, inner bellows 40 and 42 may be sized to have outer diameters greater than the diameter of central opening 54 in partition wall 38 and perhaps less than diameter of central opening 30 in end portion 26 of damper housing 28. However, these dimensions may vary in alternative embodiments, as may the general design of the isolator. Furthermore, while outer bellows 44 and 46 are sized to have larger outer diameters as compared inner bellows 40 and 42 in the illustrated example, outer bellows 44 and 46 may be sized to have smaller outer diameters relative to inner bellows 40 and 42 in further embodiments.

As described above, damper piston 20 is characterized by a “through-shaft” design such that piston shaft 52 extends axially along working axis 12 or the centerline of isolator 10 to provide a direct and stiff mechanical connection between bellows plates 48 and 50. Relative to other, more complex designs utilized to couple opposing bellows plates (e.g., bellows plates 48 and 50 shown in FIGS. 2 and 3), such a through-shaft configuration may provide several advantages including lower part count, decreased weight, and reduced envelope size. Additionally, such a through-shaft design may reduce the preload pressure requirements of fluid damper 14. Furthermore, damper piston shaft 52 does not bound an annulus or otherwise define a restricted flow orifice fluidly coupling the hydraulic chambers. Instead, an annular air gap or tubular void is created around and surrounds piston shaft 52. This annular air gap is bounded along its outer circumference by externally-pressurized inner bellows 40 and 42, as well as by central opening 54 provided in partition wall 38. The annular air gap provided around piston shaft 52 is also circumscribed by opposing hydraulic chambers 56 and 58. In this manner, orifice size is effectively decoupled from or rendered independent of the clearances provided around piston shaft 52 and, therefore, the rotational angle of capabilities of isolator 10; that is, the ability of isolator 10 to accommodate relatively large angular misalignments between mount points 32 and 34 and corresponding large rotational displacements between damper piston 20 and damper housing 22, as taken about axes orthogonal to working axis 12 (identified as the “Y-” and “Z-axes” by coordinate legend 68 in FIG. 3). The rotational angle capacity of isolator 10 is instead generally determined by the clearances provided between damper piston 20 and the interior surfaces of damper housing 22, as described more fully below.

To allow isolator 10 and, specifically, fluid damper 14 to accommodate relatively large rotational displacements between damper piston 20 and damper housing 22, several annular gaps or circumferential clearances are provided between damper piston 20 and the interior surfaces of housing 22. These circumferential clearances include: (i) a first circumferential clearance between bellows plate 48 and an inner circumference surface of damper housing 22 (identified in FIG. 3 as “C_{R1}”), (ii) a second circumferential clearance between piston shaft 52 and the inner surface of partition wall 38 defining opening 54 (identified in FIG. 3 as “C_{R2}”), and (iii) a third circumferential clearance between bellows plate 50 and the inner circumference surface of damper housing 22 (identified in FIG. 3 as “C_{R3}”). A fourth circumferential clearance (identified in FIG. 3 as “C_{R4}”) is also provided between connector rod 18 and opening 30 in housing end portion 26 to prevent contact between connector rod 18 and damper housing 22 as damper piston 20 rotates with respect thereto. The respective sizes of C_{R1}, C_{R2}, C_{R3}, and C_{R4} will vary amongst embodiments of isolator 10 and can be adjusted independent of dimensions of restricted orifices 60. Thus, C_{R1}, C_{R2}, C_{R3}, and C_{R4} can be chosen to impart isolator 10 with a relatively broad rotational angle capacity, while simultaneously imparting orifices 60 with relatively restrictive or tight dimensions. In one embodiment, C_{R1}, C_{R2}, C_{R3}, and C_{R4} are each chosen have a radial width greater than the radius of connector rod 18.

The rotational angle capabilities of isolator 10 may be further enhanced by minimizing the axial thicknesses of bellow plates 48 and 50 (as taken along working axis 12) and the longitudinal length of opening 54 in radially-extending partition wall 38. In the latter regard, it will be noted that axial thickness of partition wall 38 remains constant in the illustrated example, as considered when moving radially inward from the tubular body 28 of damper housing 22 toward working axis 12. The longitudinal length of opening 54 is thus substantially equivalent to the length of restricted orifices 60. However, in further embodiments, radially-extending partition wall 38 may decrease (e.g., taper or step downward) in axial thickness when moving radially inward toward working axis 12 such that the axial length of central opening 54 is less than the length of the restricted orifices 60 formed in partition wall 38.

The foregoing has thus provided embodiments of an isolator including a fluid damper and enabling orifice size to be adjusted independently of the rotation angle capability of the isolator. Embodiments of the isolator can be produced to include highly restricted damper orifices, while also having a relatively broad rotational angle capacity. In embodiments wherein the isolator includes highly restricted orifices, the isolator may be well-suited for usage at low operative temperatures (e.g., temperatures less than −30° C. and possibly approaching or falling below −65° C.) and with damping fluids having very low viscosities (e.g., silicone-based damping liquids having a viscosity less than about 10 cS). This notwithstanding, it is emphasized the embodiments of the isolator need not be utilized in conjunction with a low viscosity damping fluid nor include highly restricted orifices in all embodiments. Due, at least in part, to the incorporation of a through-shaft design, embodiments of the isolator may also provide relatively compact envelopes, low weights, low spring masses, and reduced pressure preload requirements. As a still further benefit, embodiments of the isolator may be characterized by relatively a small sprung mass, which may favorably increase the internal isolator modes (radial and axial) and the operational frequency bandwidth of the isolator.

While at least one exemplary embodiment has been presented in the foregoing Detailed Description, it should be appreciated that a vast number of variations exist. It should also be appreciated that the exemplary embodiment or exemplary embodiments are only examples, and are not intended to limit the scope, applicability, or configuration of the invention in any way. Rather, the foregoing Detailed Description will provide those skilled in the art with a convenient road map for implementing an exemplary embodiment of the invention. It being understood that various changes may be made in the function and arrangement of elements described in an exemplary embodiment without departing from the scope of the invention as set-forth in the appended claims.

What is claimed is:

1. An isolator having a working axis, comprising:
a damper housing, comprising:
a radially-extending partition wall; and
a central opening formed through the radially-extending partition wall;
first and second hydraulic chambers located on opposing sides of the radially-extending partition wall and configured to be filled with a damping fluid;
at least one restricted orifice formed through the damper housing and fluidly coupling the first and second hydraulic chambers; and
a damper piston extending through the central opening, exposed to the damping fluid when the first and second hydraulic chambers are filled therewith, and configured to translate along the working axis with respect to the damper housing during operation of the isolator.

2. The isolator of claim 1 wherein the at least one restricted orifice is formed through the radially-extending partition wall.

3. The isolator of claim 2 wherein the at least one restricted orifice comprises a plurality of channels formed through the radially-extending partition wall and angularly spaced about the working axis.

4. The isolator of claim 1 wherein the damper piston comprises a piston shaft extending through the central opening and substantially co-axial with the working axis.

5. The isolator of claim 4 comprising an annular air gap surrounding the piston shaft.

6. The isolator of claim 4 wherein the damper piston further comprises:
a first bellows plate extending radially outward from a first end of the piston shaft and partially defining the first hydraulic chamber; and
a second bellows plate extending radially outward form a second, opposing end of the piston shaft and partially defining the second hydraulic chamber.

7. The isolator of claim 6 wherein the first bellows plate and the second bellows plate each have an outer diameter greater than the diameter of the central opening.

8. The isolator of claim 7 further comprising:
a first inner bellows sealingly coupled to the first bellows plate and partially bounding the first hydraulic chamber; and
a second inner bellows sealingly coupled to the second bellows plate and partially bounding the second hydraulic chamber.

9. The isolator of claim 8 wherein the first and second inner bellows are sealingly joined to opposing surfaces of the radially-extending partition wall.

10. The isolator of claim 8 wherein the first and second bellows circumscribe the piston shaft and are each offset therefrom by a circumferential clearance.

11. The isolator of claim 10 wherein the circumferential clearance has a radial width greater than the radius of the piston shaft.

12. The isolator of claim 8 further comprising:
a first outer bellows sealingly coupled to the first bellows plate opposite the first inner bellows and partially bounding the first hydraulic chamber; and
a second outer bellows sealingly coupled to the second bellows plate opposite the second inner bellows and partially bounding the second hydraulic chamber.

13. The isolator of claim 12 wherein the first and second inner bellows each have a first outer diameter, and wherein the first and second outer bellows each have a second outer diameter different than the first outer diameter.

14. The isolator of claim 13 wherein the first outer diameter is less than the second outer diameter.

15. The isolator of claim 1 wherein the damper housing further comprises a tubular body from which the radially-extending partition wall extends in a radially inward direction, the tubular body bounding an outer circumference of the first hydraulic chamber and an outer circumference of the second hydraulic chamber.

16. An isolator having a working axis, comprising:
opposing hydraulic chambers configured to be filled with a damping fluid;
a damper piston having a piston shaft generally co-axial with the working axis, the damper piston exposed to the damping fluid when the opposing hydraulic chambers are filled therewith; and
an annular air gap surrounding the piston shaft and circumscribed by the opposing hydraulic chambers.

17. The isolator of claim 16 further comprising a first pair of externally-pressurized bellows partially bounding the opposing hydraulic chambers and circumscribing the annular air gap.

18. The isolator of claim 17 further comprising a partition wall disposed between the opposing hydraulic chambers, the first pair of externally-pressurized bellows sealingly coupled to opposing surfaces of the partition wall.

19. The isolator of claim 18 further comprising a second pair of externally-pressurized bellows partially bounding the opposing hydraulic chambers, the first pair of externally pressure bellows disposed between the second pair of externally-pressurized bellows.

20. An isolator, comprising:
first and second hydraulic chambers configured to be filled with a damping fluid;
a radially-extending partition wall between the first and second hydraulic chambers and having a central opening therein;
at least one restricted orifice formed through the radially-extending partition wall and fluidly coupling the first and second hydraulic chambers;
a damper piston movably coupled to the radially-extending partition wall and having a piston shaft extending through the central opening;
first and second externally-pressurized bellows each sealingly coupled between the radially-extending partition wall and the damper piston; and
an annular air gap bounded along its inner circumference by the piston shaft and along its outer circumference by the first externally-pressurized bellows, the second externally-pressurized bellows, and the central opening.
